(19) United States
(12) Patent Application Publication
(10) Pub. No.: US 2026/0056830 A1
(43) Pub. Date: Feb. 26, 2026

(54) COMPUTER TASK MANAGEMENT SYSTEM AND METHOD

(71) Applicant: Lenovo (Singapore) Pte. Ltd., Singapore (SG)

(72) Inventors: Mark Edward Molander, Cary, NC (US); Andrew James Palay, Chapel Hill, NC (US); Daniel Bondas, Morrisville, NC (US)

(21) Appl. No.: 19/306,190

(22) Filed: Aug. 21, 2025

Related U.S. Application Data
(60) Provisional application No. 63/686,059, filed on Aug. 22, 2024.

(51) Int. Cl. G06F 11/07

(52) U.S. Cl. CPC G06F 11/0793; G06F 11/0709; G06F 11/079

(57) ABSTRACT

A computer task management system and method are described that detect an issue regarding a first computer device of monitored computer devices, and determine a remedial action to address the issue. The issue and the remedial action constitute a task item. The system and method assign the task item to a first user of multiple different users for managing the task item. The system and method determine an automation level for the task item based on one or more factors, including a proficiency of the first user at managing the task item. The automation level represents an extent of user involvement required to achieve the remedial action. The system and method generate a notification message for presentation on a display device. The notification message includes graphical content that identifies the issue and the remedial action. The graphical content is based on the automation level.

### CROSS-REFERENCE TO RELATED APPLICATIONS

This application relates to and claims priority benefits from U.S. Provisional Patent Application No. 63/686,059, filed Aug. 22, 2024, titled, “COMPUTER TASK MANAGEMENT SYSTEM AND METHOD,” the subject matter of which is herein incorporated by reference in its entirety.

### FIELD

The present disclosure generally relates to systems that monitor groups of computer devices to maintain operation of the computer devices over time and avoid performance interruptions.

### BACKGROUND OF THE INVENTION

Some systems monitor groups of computer devices and perform tasks to maintain operation of the computer devices over time with limited downtime. The computer devices that are monitored may be organized in multiple clusters located in different facilities, such as data centers. Example computer devices can include servers. The clusters of computer devices may perform cloud computing to provide on-demand availability of data storage, computing power, and/or other computer system resources through a network. Task management systems can be employed to monitor the groups of computer devices and alert users (e.g., human operators) when an issue is detected that needs to be addressed before the issue interrupts the computer operations. Some issues can include warranties expiring, software and firmware requiring updates, hardware needing to be replaced, and/or the like. The computer task management system detects issues that require attention, and generates tasks for presentation to a user assigned to manage the computer devices. One example task may be to renew a warranty on a first computer. A second task may be to update software on a second computer. The computer task management system may display the tasks on a graphical user interface (GUI). A user is able to view the GUI and interact with the GUI to address the tasks and keep the computer devices up-to-date and operational.

Known computer task management systems have several drawbacks that result in inefficient and ineffective management of the monitored computer devices. For example, the computer task management system may perform the same or a similar sequence of computational operations each time that a new issue is detected. The computational operations may involve analyzing the issue, determining an appropriate remedial action to address the issue, and generating a discrete notification message to display a new task on the GUI. The task management system may be inefficient by performing redundant computational operations for a multitude of individual, low-level tasks. The GUI can get cluttered by the multitude of tasks to manage, which makes it difficult for users to discern relevant tasks and prioritize the tasks.

Furthermore, the task management system may display the same pending tasks to respective devices of multiple users that have access to the system, without differentiating the task-related information provided to different users. The task management system may not assist users with determining which user should address certain tasks. It may be difficult for different users, such as members of an information technology (IT) team, to discern which user is the most appropriate user to handle a first task and which user is most appropriate to handle a second task in order to provide reliable and efficient task management. In another example, a task management system may only present a certain task to the computer of a single specific user, without notifying other users about the task. This approach lacks transparency. A given task may not be timely addressed and completed if the specific user that is notified is not available or competent.

A need remains for a computer task management system that can seamlessly accommodate users that have varying proficiency levels for different types of tasks, while reliably and efficiently managing the monitored computer devices to reduce the risk of interrupted operation.

### SUMMARY

In accordance with an example or aspect, a method for managing and monitoring computer devices is provided that includes detecting an issue regarding a first computer device in a group of monitored computer devices, and determining, via one or more processors, a remedial action to address the issue. The issue and the remedial action constitute a task item. The method includes assigning the task item to a first user of multiple different users for managing the task item and determining, via the one or more processors, an automation level for the task item based on one or more factors. A first factor of the one or more factors is a proficiency of the first user at managing the task item. The automation level represents an extent of user involvement that is required to achieve the remedial action. The method includes generating, via the one or more processors, a notification message for presentation on a display device. The notification message includes graphical content that identifies the issue and the remedial action to address the issue. The notification message is generated so that the graphical content that is displayed is based on the automation level.

Optionally, determining the automation level for the task item may include selecting the automation level to be proportional to a level of the proficiency of the first user at managing the task item. Another factor of the one or more factors may be a risk tolerance associated with the task item. Determining the automation level for the task item may include selecting the automation level to be less automated when the task item has a low risk tolerance and selecting the automation level to be more automated when the task item has a high risk tolerance. Another factor of the one or more factors may be a success rate of prior task items that have respective issues that are the same or similar to the issue of the task item. Determining the automation level for the task item may include inputting an identification of the issue and an identity of the first user to a machine learning algorithm.

The method may include displaying the notification message on a screen of the display device for viewing by the first user. The method may include one of (i) automatically performing the remedial action or (ii) scheduling for automated performance of the remedial action at a future time, independent of receiving consent from the first user, when the automation level is a high automation level. The method may include one of (iii) automatically performing the remedial action or (iv) scheduling for the automated performance of the remedial action at the future time, dependent on receiving consent from the first user, when the automation level is a second automation level that is less automated than the high automation level. The method may include one of (v) displaying instructions on the display device for user-assisted performance of the remedial action or (vi) prompting the first user to schedule automated performance of the remedial action, when the automation level is a third automation level that is less automated than the second automation level.

The issue regarding the first computer device may include an expiring warranty, outdated software, outdated firmware, a defective hardware component, and/or a hardware component approaching an end of a designated operating lifetime of the hardware component. The remedial action to address the issue may include renewing the warranty of the first computer device that is expiring, updating the software that is outdated, updating the firmware that is outdated, and/or ordering at least one hardware component for the first computer device to replace the defective hardware component and/or the hardware component that is approaching the end of the designated operating lifetime. The method may include determining a weighted score for at least some of the multiple different users based on weight values assigned to the different users with respect to multiple user factors. Assigning the task item to the first user may include comparing the weighted score of the first user to the weighted scores of other users in the multiple different users.

Generating the notification message may include presenting a virtual button on a graphical user interface. The virtual button may be presented to prompt the first user to affirm or initiate the remedial action, based on the automation level that is determined. Generating the notification message may include presenting a virtual button on a graphical user interface. The notification message may be generated so that graphical content on the virtual button prompts the first user to track progress of the remedial action when the automation level is a high automation level and the graphical content on the virtual button prompts the first user to initiate the remedial action when the automation level is a low automation level.

In accordance with an example or aspect, a computer management system is provided that includes a memory configured to store program instructions and one or more processors operably connected to the memory. The program instructions are executable by the one or more processors to detect an issue regarding a first computer device in a group of monitored computer devices and determine a remedial action to address the issue. The issue and the remedial action constitute a task item. The program instructions are executable by the one or more processors to assign the task item to a first user of multiple different users for managing the task item. The program instructions are executable by the one or more processors to determine an automation level for the task item based on one or more factors. A first factor of the one or more factors is a proficiency of the first user at managing the task item. The automation level represents an extent of user involvement that is required to achieve the remedial action. The program instructions are executable by the one or more processors to generate a notification message for presentation on a display device. The notification message includes graphical content that identifies the issue and the remedial action to address the issue. The notification message is generated so that the graphical content that is displayed is based on the automation level.

Optionally, the program instructions may be executable by the one or more processors to determine the automation level for the task item by selecting the automation level to be proportional to a proficiency level of the first user at managing the task item. The program instructions may be executable by the one or more processors to one of (i) automatically perform the remedial action or (ii) schedule for automated performance of the remedial action at a future time, independent of receiving consent from the first user, when the automation level is a high automation level. The program instructions may be executable by the one or more processors to one of (iii) automatically perform the remedial action or (iv) schedule for the automated performance of the remedial action at the future time, dependent on receiving consent from the first user, when the automation level is a second automation level that is less automated than the high automation level. The program instructions may be executable by the one or more processors to one of (v) display instructions on the display device for user-assisted performance of the remedial action or (vi) prompt the first user to schedule automated performance of the remedial action, when the automation level is a third automation level that is less automated than the second automation level.

In accordance with an example or aspect, a computer program product including a non-transitory computer readable storage medium is provided. The non-transitory computer readable storage medium includes computer executable code configured to be executed by one or more processors to detect an issue regarding a first computer device in a group of monitored computer devices and determine a remedial action to address the issue. The issue and the remedial action constitute a task item. The computer executable code is configured to be executed by one or more processors to assign the task item to a first user of multiple different users for managing the task item and determine an automation level for the task item based on one or more factors. A first factor of the one or more factors is a proficiency of the first user at managing the task item. The automation level represents an extent of user involvement that is required to achieve the remedial action. The computer executable code is configured to be executed by one or more processors to generate a notification message for presentation on a display device. The notification message includes graphical content that identifies the issue and the remedial action to address the issue. The notification message is generated so that the graphical content that is displayed is based on the automation level.

### BRIEF DESCRIPTION OF THE DRAWINGS

FIG. 1 is a block diagram of a computer management system according to an embodiment.

FIG. 2 illustrates example low automation level notification messages displayed on a display device of a user device according to an embodiment.

FIG. 3 illustrates example intermediate automation level notification messages displayed on a display device of a user device according to an embodiment.

FIG. 4 illustrates example high automation level notification messages displayed on a display device of a user device according to an embodiment.

FIG. 5 is a chart that lists weight values assigned to three different users for different factors according to an embodiment.

FIG. 6 is a chart that includes score values representing the risk tolerance of different computer devices in the group of monitored computer devices according to an embodiment.

FIG. 7 is a flow chart of a method of managing and monitoring computer devices according to an embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

References herein to “computer device”, unless specified, shall mean any of various types of hardware devices that perform processing operations, such as servers, computer workstations, personal computers, and the like. The personal computers may include laptop (e.g., notebook) computers, desktop computers, tablet computers, smartphone computers, wearable computers, and the like.

As used herein, the terms “software program”, “software”, and “program” are interchangeable and shall mean a set of instructions programmed on a hardware device, such as a computer device. The instructions are executable by the hardware device to perform a function. These terms “software program” and “software” encompass different classes of software, such as embedded server firmware, component firmware, component drivers, operating systems, and applications. Firmware provides low-level control for the corresponding device to interact with other computer hardware. A specific software program may have different versions over time.

References herein to “machine learning” shall mean artificial intelligence (AI) algorithms that learn from various automatic or manual feedback, such as observations and/or data. The AI algorithms may be adjusted over multiple iterations based on the observations and/or data. For example, the AI algorithms may be adjusted by supervised learning, unsupervised learning, and/or reinforcement learning (e.g., customer feedback). Non-limiting examples of AI algorithms include decision trees, K-means, deep learning, artificial neural networks, and/or the like.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The computer task management system described herein intelligently assigns the task items to appropriate users for reliably and efficiently managing the monitored computer devices to maintain uninterrupted operation of the monitored computer devices. The computer task management system also intelligently determines which level of automation is appropriate for addressing a particular task item.

The embodiments described herein avoid drawbacks of known computer task management systems. For example, people may not want select settings for every aspect of using a program, like a task management tool. Some people have performed a certain type of task many times, and these experienced veterans may not need to be hands on for responding to every new task of that type. However, if a new task is particularly important to the operational fortitude of monitored computer devices and/or the user does not have much experience addressing the new task, then it may be appropriate for the user to be more active in addressing the issue.

Known task management systems do not adjust the automation level on the fly based on factors, and this omission has several drawbacks. For example, task management systems that are more manual (e.g., reliant on the user) can be inefficient at handling a large number of tasks, as the throughput is dependent on the user's continuous intervention. Humans take longer than automated systems to detect and respond to issues. This delay can be problematic in situations where rapid response is critical to avoid or limit damage or system downtime. Human error is inherent in manual systems, as humans can make mistakes due to fatigue, distraction, or simple oversight. This can lead to inaccurate monitoring of the system and missed issues. The system reliability may be hampered by the use of people, as human performance itself may vary from person to person based on attentiveness, proficiency, and/or the like.

Fully automated task management systems take the user out of the loop. Although efficient, the fully automated system is unconstrained and may suffer from the lack of human judgment, over-reliance on technology, existence of false positives and/or false negatives, security vulnerabilities, inability to adapt to unexpected situations or changes in the environment. For example, automated systems may lack the ability to make nuanced decisions or interpret complex situations that require human judgment, resulting in inappropriate or inadequate responses. The systems may fail in situations that deviate from programmed parameters and expected conditions. The over-reliance on technology can lead to complacency among human operators, reducing their vigilance and potentially leading to failures if the system malfunctions. The automated system may generate false alarms or fail to detect real issues. This can erode trust in the system and lead to critical problems being overlooked.

The embodiments described herein provide a computer task management system that seamlessly accommodates users that have varying proficiency levels for different types of tasks. The computer task management system accommodates users by determining a level of automation for interacting with the user and resolving a given task. The system may determine the level of automation based, at least in part, on the proficiency levels of the users assigned to manage the tasks. For each task item, the controller of the computer task management system may determine a remedial (e.g., responsive) action to take to resolve the relevant issue. Some example remedial actions can include renewing a warranty for a first computer device, order and installing a replacement component for the first computer device, updating software in the first computer device, updating firmware in the first computer device, and/or the like. The controller may assign responsibility for managing the task item to a particular user, such as a specific IT professional.

In the embodiments described herein, the controller selects an automation level for each respective task item. The automation level affects how the remedial action is performed by the system controller and what information is conveyed to the assigned user in the form of a notification message. How the remedial action is performed refers to the balance of power between the automated system and the assigned human user.

The automation level can be a scale between fully automated at one end and manual at the other end. In a fully automated mode, the system may automatically perform the remedial action independently of input from the user. In a manual mode, the system may require the user to be involved in all steps of the remedial action, such as to order a replacement part. In an example intermediate (e.g., semi-automated) mode, the system may automatically perform the remedial action, dependent on receiving an indication of consent or approval from the user.

The automation level also affects the information that is presented to the assigned user in the notification message. For example, the notification message may have graphical content that is displayed on a display device for observation by the assigned user. The system controller may vary the graphical content of the notification message based on the automation level to show only relevant information to the assigned user. For example, in the manual mode, the notification message may be generated so the graphical content includes detailed, step-by-step instructions or guides to assist the assigned user with carrying out the remedial action. In the intermediate mode, the graphical content of the notification message may include a virtual button that enables “1-click” approval of the proposed remedial action. The system controller may perform or schedule the remedial action in response to receiving a user input selection of the “1-click” virtual button. In the fully automated mode, the system controller may automatically perform or schedule the remedial action. The graphical content of the notification message in that case may describe the action that the system has already performed, or will perform. The assigned user may be a passive observer. The graphical content may indicate the current status and/or progress of the remedial action to resolve the task item.

The computer task management system of the embodiments described herein may assist the user by selecting the automation level, based at least in part on the proficiency of the user, to help the user address and resolve the task. The automation level may be selected based on the task as well as the user. For example, the system may determine the automation level by analyzing a relationship between the assigned user and the task item. For example, the system may analyze historical data associated with the first user managing previous task items that have respective issues that are the same or similar to the issue of the task item. The level of automation affects the information provided to a user in the form of a notification message, and determines which actions, if any, are automatically performed by the system controller independent of the user providing explicit approval.

The embodiments described herein improve the functionality of computers and solve technical problems. The embodiments described herein provide efficient and effective management of the monitored computer devices. The computer task management system may reduce the level of knowledge that a person (e.g., user) may need to monitor the computer devices and respond to issues for maintaining operation of the computer devices.

The system utilizes a spectrum between manual and fully automated task administration. The interplay between the users and the automated system can enable both the users and the system to improve over time. For example, the automated system may adjust to human-provided decision-making. Efficiency and productivity can increase by automating the response to tasks that are well-known to the assigned user and/or have a high risk tolerance. Furthermore, for tasks in which the assigned user is a novice and/or the risk tolerance is low (e.g., a critical task), the automated system may select a more manual automation level to guide the user through the process for resolving the task. By varying the level of automation, the system described herein may increase efficiency and productivity of task management without sacrificing accuracy or increasing the risk of performance interruptions of the monitored computer devices.

Furthermore, the computer management system described herein solves technical problems by assigning different roles to different users with respect to a particular task item. For example, rather than display the same information to different users and ask the users to volunteer for managing tasks, the computer management system may select one or more of the users for roles related to handling the tasks based on various factors relating to suitability of the users to the tasks. After assigning one or more of the users to roles, the computer management system may differentiate the information displayed to the different assigned users based on the roles. For example, a first notification message generated for display to a first user (designated as the primary user to handle a task item) may be different than a second notification message generated for display to a second user (designated as the secondary user to handle the task item as a fallback to the first user). The first notification message may identify the issue in the task item, including the affected computer devices, and prompt the primary user to affirm a remedial action to address the issue. The second notification message may identify the issues in the task set and identify the primary user. The second notification message may prompt the secondary user to voluntarily assume responsibility for handling the task item instead of the first user.

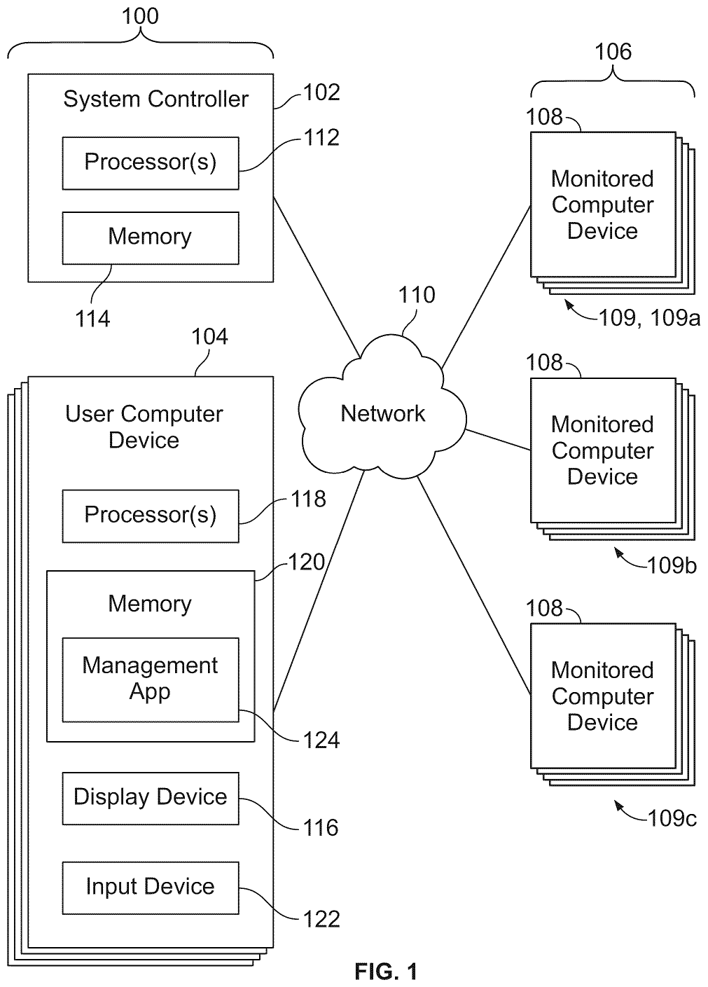

FIG. 1 is a block diagram of a computer task management system 100 according to an embodiment. The computer task management system 100 includes a system controller 102 that performs computer task management operations described herein. Such operations include detecting issues regarding monitored computer devices, determining remedial actions to address each of the issues, assigning task items (constituting the issues and respective remedial actions) to appropriate users for managing the task items, determining automation levels for the corresponding task items, and generating notification messages based on the automation levels.

The computer task management system 100 (referred to herein as computer management system) also includes user computer devices 104 (referred to herein as user devices). The user devices 104 may be associated with different users. In an example, the users are human people. The users may be affiliated with a company, a government organization, an educational institution, or the like. In an example, the users may include information technology (IT) professionals, such as IT professionals employed by a company that is contracted to monitor the group 106 of computer devices 108. The user devices 104 may be associated with different users by being owned by different corresponding users, being assigned to different corresponding users, being operated by different corresponding users, and/or the like. For example, a first user device 104 may be a general user device that is only associated with a first user in response to the first user providing unique identifying credentials to access and operate the first user device 104.

The system controller 102 is communicatively connected to the user devices 104. For example, the system controller 102 may be communicatively connected to the user devices 104 via a network 110. The network 110 may be the Internet, a local area network (LAN), or the like. The components in the network 110 may be communicatively connected to each other via wired and/or wireless communication links to permit the transmission of information in the form of signals.

The computer management system 100 may monitor a group 106 of computer devices 108 (e.g., monitored computer devices). For example, the computer management system 100 may monitor the computer devices 108 to keep the computer devices 108 operating without (or limited) interruption.

The computer devices 108 may be computers, servers, and/or the like. At least some of the computer devices 108 may be used to provide cloud computing and/or cloud data storage services. The computer devices 108 may be arranged in different clusters 109 based on location, use, type of computer device, and/or the like For example, the computer devices 108 may be located at different data centers. A first cluster 109a of the computer devices 108 may be located at a first data center, a second cluster 109b may be located at a second data center, and a third cluster 109c may be located at a third data center. The different data centers may be in different rooms of a common building, in different buildings in the same city, or in different cities. The computer devices 108 in the group 106 may be communicatively connected to each other and to the computer management system 100 via the network 110.

The computer management system 100 may be responsible for tracking the operating lifetimes, cycles, run time, and/or the like of the computer devices 108 and components thereof. The computer management system 100 may determine when to replace individual computer devices 108 and/or hardware components thereof in an attempt to avoid unexpected faults that interrupt operation. The computer management system 100 may also determine when to update software and/or firmware installed on the computer devices 108 to keep the computer devices 108 up-to-date.

In an example, the computer management system 100 may also determine when to renew warranties which cover the computer devices 108 as well as software and/or firmware installed thereon, before the warranties expire. In an example, the computer management system 100 may collect performance data related to the operating performance of the computer devices 108 and sensor measurements related to the condition of the computer devices 108.

The computer management system 100 may monitor the performance data and sensor measurements over time to determine trends that the system 100 may use to predict the likelihood of faults (e.g., operating interruptions) at a future time. The computer management system 100 may generate notification messages to inform appropriate users about the detected existence of, or predicted risk of, an issue which could interrupt operation of the computer devices 108.

The system controller 102 represents hardware circuitry that includes and/or is connected with one or more processors 112 (e.g., one or more microprocessors, integrated circuits, microcontrollers, field programmable gate arrays, etc.). The system controller 102 includes and/or is connected with a tangible and non-transitory computer-readable storage medium, referred to herein as memory 114. The memory 114 may store programmed instructions (e.g., software) that are executed by the one or more processors 112 to perform the task management operations described herein. For example, the programmed instructions may be utilized by the one or more processors 112 to detect and analyze an issue regarding a first computer device 108 in the group 106 of monitored computer devices 108. The programmed instructions may be utilized by the one or more processors 112 to determine a remedial action to address the issue. The issue and the remedial action constitute a task item. The programmed instructions may be utilized by the one or more processors 112 to assign the task item to a first user of multiple different users for managing the task item. The programmed instructions may be utilized by the one or more processors 112 to generate a notification message for presentation on a display device 116 of at least one of the user devices 104. The notification message may include graphical content that identifies the issue and the remedial action. The one or more processors 112 may generate the notification message so that the graphical content is based on the automation level for the task item. The one or more processors 112 may determine which aspects of the remedial action, if any, can be performed automatically by the one or more processors 112, and the time of the performance of those aspects, based on the automation level.

The user devices 104 enable the users to interact with the computer management system 100. Example user devices 104 may include smartphones, tablet computers, laptop computers, hands-free digital assistant devices, desktop computers, wearable computers, computer workstations, and/or the like. The user devices 104 may include a display device 116, one or more processors 118, a tangible and non-transitory computer-readable storage medium, referred to herein as memory 120, and a user input device 122. These components may be commonly held within or on a housing or case of the respective user device 104. Each user device 104 may have additional components that are not shown in FIG. 1, such as communication circuitry for communicating with the system controller 102 through the network 110.

The one or more processors 118 may include one or more microprocessors, integrated circuits, microcontrollers, field programmable gate arrays, and/or the like. The memory 120 may store programmed instructions (e.g., software) that are executed by the one or more processors 118 to perform tasks described herein, such as presentation of notification messages on the display device 116 for observation by the user. The display device 116 includes a display screen that presents graphical content, such as images, shapes, text and symbols, for observation. The display screen may be an LCD screen or the like. The display device 116 also includes hardware and software components used to display graphical content on the display screen. For example, the display screen may be illuminated by an array of light emitting elements of the display device 116. The light emitting elements may be controlled by a graphical processing unit (GPU) of the display device 116.

The display device 116 may display a graphical user interface (GUI) of a program (e.g., application) or website. The system controller 102 may generate notification messages that are communicated to one or more of the user devices 104 and used to present graphical content on the display device 116 to alert and inform the associated user about a task item.

The user input device 122 may include one or more devices for providing user input selections, such as a touch screen, a touchpad, a keyboard, buttons, a dial, a microphone, and the like. A user may use the input device 122 to generate user input selections that are communicated from the user device 104 to the system controller 102. The user may provide a user input selection by clicking a mouse button, tapping a touch screen or pad, or the like. The input device 122 may generate an electrical signal in response to receiving the physical touch interaction from the user. The electrical signal may be transmitted to the system controller 102. The user may provide a user input selection to respond to a notification message, such as by affirming a remedial action presented in the notification message. In another example, the user input device 122 may include a microphone or other audio input device that receives audio commands from the user. The user input device 122 may include a transducer that converts the audio commands to electrical signals to be transmitted to the system controller 102. In this example, the user may audibly provide the user input selection to respond to the notification message.

In an example, the memory 120 of the user device 104 may store a management application 124 which is specific to the computer management system 100. For example, a user may selectively activate or “open” the management application 124 on the user device 104 to interact with the computer management system 100 (e.g., the system controller 102). The management application 124 may include a graphical user interface (GUI) that is displayed on the display screen when the management application 124 is active. The notification messages may be presented on the GUI. For example, the GUI may format and display the graphical content of the notification messages for viewing by the user. The GUI may enable the user to submit user input selections via the input device 122. For example, the GUI may present a virtual button. A user operating one of the user devices 104 may utilize the management application 124 to selectively affirm a remedial action by providing a user input selection on the virtual button.

The system controller 102 is a computer device or a portion of a computer device. For example, the system controller 102 may be part of a server. The system controller 102 is illustrated in FIG. 1 as discrete and separate from the user devices 104 and the monitored computer devices 108. In another example, the system controller 102 may be part of one of the user devices 104.

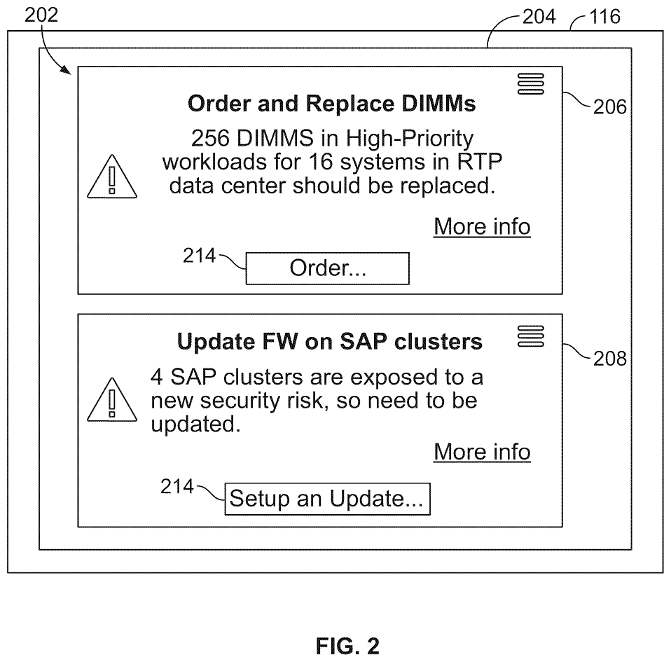

FIG. 2 illustrates example notification messages displayed on a display device 116 of a user device 104 according to an embodiment. The notification messages are presented on a GUI 202. The GUI 202 presents graphical content generated by the system controller 102 of the computer management system 100. For example, the graphical content of the GUI 202 is based on a notification message generated by the system controller 102. The notification message is transmitted from the system controller 102 to the display device 116 for presenting the GUI 202 on the screen 204 of the display device 116.

In the illustrated embodiment, the notification message identifies two different task items (or task sets). The GUI 202 includes a first task window 206 and a second task window 208. The first task window 206 describes a first task item, and the second task window 208 describes a second task item. The task items may be generated by the system controller 102. Each task item includes a detected issue that relates to at least one computer device 108 in the group 106 that is being monitored. The issue in the first task item is that several computer devices 108 need to replace a hardware component. The hardware component in an example is a data storage device. For example, the first task item indicates that sixteen (16) computer devices 108 in one data center have dual in-line memory modules (DIMMs) that need to be replaced. The issue in the second task item is that several computer devices 108 need a firmware update. More specifically, four clusters of the computer devices 108 need a firmware update due to exposure to a new security risk.

The system controller 102 generates the notification message so that the graphical content in each of the task windows 206, 208 identifies the computer devices 108 that are affected by the issue and provides a brief description of the issue. The graphical content in each task window 206, 208 also identifies a remedial action for addressing the corresponding issue. The remedial actions may be determined by the system controller 102. For example, the remedial action to address the DIMMs in the first task window 206 is to order and replace the DIMMs on the 16 affected computer devices 108. The remedial action to address the four clusters of computer devices 108 exposed to the security risk in the second task window 208 is to update the firmware of the affected computer devices 108. Other example remedial actions could include renewing the warranties of the computer devices 108 that have expiring warranties, updating software of computer devices 108 that have outdated software, ordering and installing new hardware components to replace hardware components in computer devices 108 that are reaching the end of designated operating lifetimes, and/or the like. In an example, the brief description of the issue may include information about a source or cause of the issue, a location of the affected computer devices 108, and/or a suggested time period in which to perform the remedial action.

In an example, the system controller 102 may generate the notification message to include at least one virtual button for prompting the user to interact with the computer management system 100. The virtual buttons may be associated with the remedial action. For example, one type of virtual button 214, referred to herein as an affirmance button, may enable the user to selectively affirm and initiate the remedial action. Another type of virtual button 216, referred to herein as a modification button, may allow the user to selectively modify or postpone the remedial action. In FIG. 2, both task windows 206, 208 have a respective affirmance button 214. The virtual button 214 in the first task window 206 states, “Order . . . ,” which refers to ordering the replacement DIMMs for the affected computer devices 108. The virtual button 214 in the second task window 208 states, “Setup an Update,” which refers to the firmware update for the affected computer devices 108. There may or may not be any overlap in the computer devices 108 associated with the different task items (e.g., described in the two task windows 206, 208). The virtual buttons 214 may be displayed below the brief description in the respective task window 206, 208. The user may select the virtual button(s) 214 via manipulating the input device 122. For example, the user viewing the display device 116 may tap the touch-sensitive screen 204 at a location of the virtual button 214 to indicate affirmance of the remedial action. In another example, the user may manipulate a mouse or other device to move a cursor over the virtual button 214 and then press a button on the mouse to select the virtual button 214.

The computer management system 100 assigns a user to manage each task item. The two task items shown in FIG. 2 are assigned to the same user. For example, there may be a pool of multiple different users that could be selected to handle each task item. The user that is assigned to handle a given task is referred to herein as the primary (or assigned) user. The primary user has the primary role in addressing and resolving the task item. The primary user may resolve the task item by taking action to perform, initiating the automated performance of, or simply monitoring the automated performance of the remedial action determined by the system controller 102.

The computer management system 100 selects a level of automation for task management based on one or more factors. One of the factors is the proficiency of the assigned (primary) user at managing the task item. The proficiency of the assigned user refers to the competency of the specific user at handling the type of issue in the task item by performing the remedial action. The computer management system 100 may have multiple different automation levels (or modes) from which to select. The automation level affects the information that is provided to the primary user in the notification message and the dependency of the system controller 102 on the primary user to address the task item. For example, the automation level affects to how much user intervention is sought by the computer management system 100 to address the task item. The automation level affects whether and what action(s) are automatically taken by the system 100 without waiting for explicit approval by the assigned user. In short, the automation level represents the extent of user involvement that is required to achieve the remedial action.

For example, a higher automation level is more automated than a lower automation level. The higher automation level is less reliant on the primary user to address the task item. For the higher automation level, the system controller 102 may automatically perform the remedial action, or parts of the remedial action, without relying on input by the primary user. For the lower automation level, the system controller 102 may not perform the remedial action, or parts thereof, unless and until the primary user provides explicit affirmance.

The automation level also affects the information that is presented to the user on the display device 116. For example, when the system 100 generates the notification message to inform the user about the task item, the graphical content of the notification message is based on the automation level. The graphical content may simply inform the user about the task and the remedial action that was or will be performed, or may explicitly request the user to provide instruction or approval before the system performs the remedial action.

In an example, the system controller 102 selects the automation level from among three different automation levels. The automation levels include a high automation level, a low automation level, and an intermediate automation level. The high automation level is the closest level to fully automated task management. The system controller 102 is the most autonomous in the high automation level. The low automation level is the closest level to manual, and requires the most intervention by the assigned user to manage a given task. The intermediate automation level is between the high and low automation levels in terms of the reliance on the assigned user and autonomy of the system controller 102. The intermediate automation level may be referred to as partially automated. Although three automation levels are described in examples presented herein, the computer management system 100 may have only two automation levels or at least four automation levels in other example embodiments.

FIG. 2 shows example notification messages that are generated by the system controller 102 after selecting the low automation level for the two task items at issue. In the low automation level, the system controller 102 requires user intervention before performing the remedial action. As examples, a notification message in the low automation level may provide instructions for ordering a replacement part, installing the replacement part, updating software, updating firmware, renewing a warranty, and/or the like. The notification message may guide the user through the process with step-by-step instructions. In FIG. 2, the brief description in the first task window 206 indicates that the DIMMs for the affected computer devices 108 in the data center should be replaced, and the affirmance button 214 states, “Order . . . .” The primary user may select the affirmance button 214, via the input device 122, to open a form or wizard for ordering the replacement DIMMs. The GUI 202 may show a new window that represents the ordering form or wizard. The user may be able to input information about the type of component, the number of components, the shipping address, form of payment, and/or the like. The brief description in the second task window 208 indicates that the computer devices 108 exposed to the new security risk need to be updated, and the affirmance button 214 states, “Setup an Update . . . .” The primary user may select the affirmance button 214 of the second task window 208, via the input device 122, to open a new window for setting up the firmware update. For example, the GUI 202 may show a new window that represents a firmware update setup menu. The firmware update setup menu may guide the primary user through the firmware update process. For example, the firmware update setup menu may prompt the user to input information identifying the affected computer devices 108, the firmware to be updated, the time for the update to begin, and/or the like. In general, the system controller 102 in the low automation level is dependent on the primary user. The system controller 102 may rely on and wait for the primary user to affirm the remedial action before taking the remedial action.

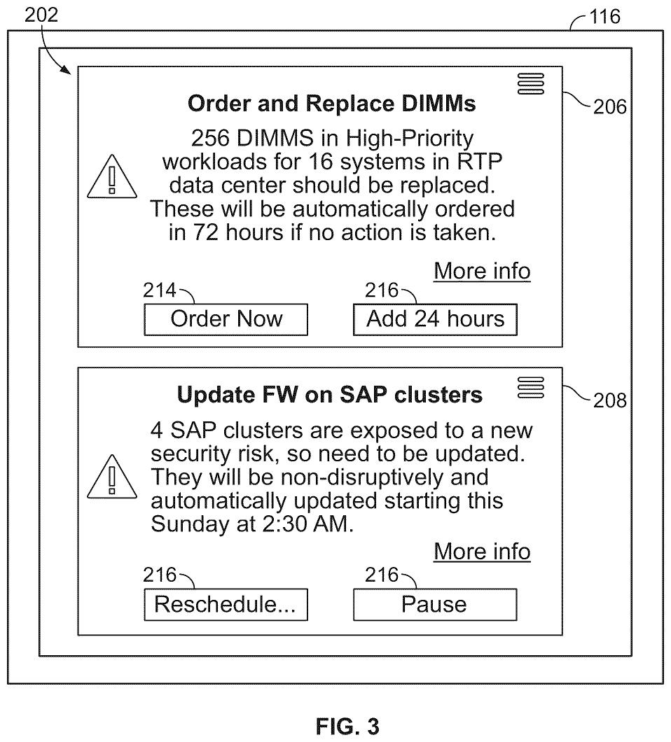

FIG. 3 illustrates example intermediate automation level notification messages displayed on a display device 116 of a user device 104 according to an embodiment. The notification messages may be directed to the same task items at issue as shown in FIG. 2. The system controller 102 may vary the graphical content displayed in the GUI 202 depending on the automation level that is determined.

In the illustrated example, the first task window 206 in the GUI 202 includes the same text from the heading and brief description of the first task window 206 in FIG. 2. The brief description in FIG. 3 adds a default remedial action that the system controller 102 will automatically pursue unless the primary user intervenes to modify the plan. In this example, the system controller 102 will automatically order the new DIMMs in 72 hours if no action is taken by the primary user. In the intermediate automation level, according to this example, the system controller 102 describes the planned automated action that will occur at a designated time in the future unless the user intervenes. Thus, the system controller 102 is not longer dependent on the primary user before taking action. However, the system controller 102 in the intermediate automation level does not perform the remedial action yet. The system controller 102 schedules the automated performance of the remedial action for the designated future time.

The affirmance button 214 in the first task window 206 provides a “1-click” option for the primary user to affirm the remedial action. For example, the affirmance button 214 states “Order Now,” indicating that the system controller 102 will automatically order the new DIMMs, prior to the designated future time, in response to the user selecting the button 214. For example, the system controller 102 may determine the order details, such as type of components (DIMMs) to order, shipping location, payment source, and the like, without relying on the primary user. The primary user may simply select the button 214 to approve the order. The first task window 206 may include a modification button 216. The modification button 216 in this example allows the primary user to selectively delay or postpone the performance of the remedial action (e.g., the ordering of the new DIMMs). The modification button 216 may state, “Add 24 hours.” The primary user may select the modification button 216, via the input device 122, to instruct the system controller 102 to delay ordering the DIMMs until one day (e.g., 24 hours) after the scheduled future time. If the user does not select the modification button 216, the system controller 102 will order the new DIMMs at the designated future time even if the user takes no action.

In the illustrated example, the second task window 208 includes the same text from the heading and brief description of the second task window 208 in FIG. 2. The brief description in FIG. 3 adds the default remedial action. In this example, the system controller 102 adds to the brief description that the affected computer devices 108 will be non-disruptively and automatically updated starting Sunday at 2:30 AM. Thus, the default remedial action is to update the firmware on the affected computer devices 108 starting Sunday at 2:30 AM. As with the first task, the system controller 102 schedules the automated performance of the remedial action to address the second task for a designated future time. The remedial action is to update the firmware on the affected computer devices 108, and the designated future time is Sunday at 2:30 AM. In the illustrated example, the second task window 208 includes two modification buttons 216. One modification button 216 states, “Reschedule” and allows the primary user to selectively reschedule the firmware update starting time. The other modification button 216 states, “Pause” and allows the primary user to postpone the firmware update. Although not shown in FIG. 3, the second task window 208 may include an affirmance button that allows the user to selectively start the firmware update process, without waiting until the scheduled time in the future.

In general, when operating in the intermediate automation level, the system controller 102 may schedule the remedial action for automated performance at a scheduled future time. The notification message may allow the primary user to change and/or delay the default remedial action, but the system controller 102 does not require the primary user's intervention to perform the remedial action. The notification message may provide a virtual (affirmance) button 214 for 1-click ordering, updating, renewing, scheduling, etc. The virtual button 214 may allow the user to affirm the remedial action for the system controller 102 to perform the remedial action without waiting for the time period to expire.

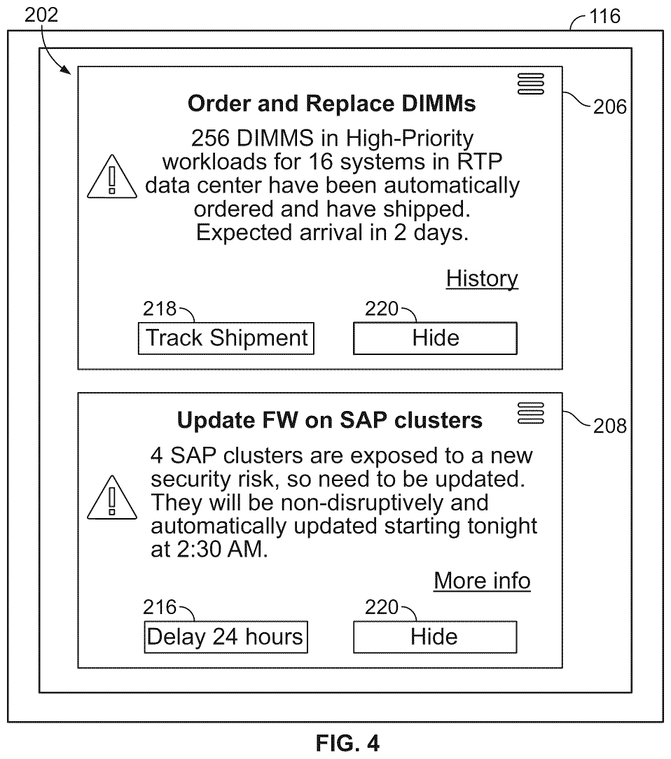

FIG. 4 illustrates example high automation level notification messages displayed on a display device 116 of a user device 104 according to an embodiment. The notification messages may be directed to the same task items at issue as shown in FIGS. 2 and 3. When operating in the high automation level, the system controller 102 may automatically perform, schedule, or initiate performance of the determined remedial action to address the issue of the task item. The system controller 102 does not rely on the primary user, and optionally may not provide a grace period for the user before taking the automated action(s). The system controller 102 in the high automation level may take action to address the task item without waiting for, or relying on input by, the primary user.

The system controller 102 may generate the notification message to describe the automated remedial action that was taken or is being taken. The notification message may provide the user the opportunity to track the progress of the remedial action that is automatically performed or initiated by the system controller 102. In an example, the notification message may provide the estimated completion time, such as the arrival date of a replacement part. The notification message may have a virtual button that can be selected by the primary user to track a shipment of a replacement part. In an example, the notification message may enable the user to opt in to intervene, such as to delay or modify the performance of any part of the remedial action that is not already executed. For example, the notification message may allow the user to pause and/or cancel a shipment if user intervenes within a designated grace period (e.g., initial time period) from the time the order was placed. An example grace period may be 24 hours.

In the illustrated example, the brief description in the first task window 206 is modified from the text in FIGS. 2 and 3 by stating that the replacement DIMMs “have been automatically ordered and have shipped.” The system controller 102 generates the notification message to include a virtual button 218 for tracking progress of the remedial action. The virtual button 218, referred to herein as progress button, states, “Track Shipment.” The primary user may select the progress button 218, via the input device 122, to open a new window on the GUI 202 that includes shipment information about the replacement DIMMs. The first task window 206 optionally may have a second virtual button 220 for minimizing or closing the first task window 206. The virtual button 220, referred to herein as a hide button, allows the user to selectively minimize or close the first task window 206.

The second task window 208 in FIG. 4 states that the four affected computer devices 108 “will be non-disruptively and automatically updated starting tonight at 2:30 AM.” The system controller 102 generates the notification message to include a modification button 216 to delay the update. The primary user can use the input device 122 to select the modification button 216 to delay the update 24 hours, if desired. The notification message in the illustrated example also includes a hide button 206 to selectively minimize or close the second task window 208. In another example, the system controller 102 may automatically initiate the update in the high automation level without scheduling the update for a designated future time. For example, the notification message in FIG. 4 could state that the four affected computer devices 108 are currently being updated.

During operation, the system controller 102 of the computer management system 100 monitors the group 106 of computer devices 108 to detect computer issues. The system controller 102 may detect various computer issues in the group 106 over time. The computer issues can include expiring warranties, outdated software, outdated firmware, defective hardware components, hardware components approaching the end of designated operating lifetimes for the hardware components, and/or the like. Other issues that can be detected may involve computer conditions, such as high temperature, high power usage, and/or the like. The system controller 102 may detect the issues via receipt of messages from other devices, receipt of sensor signals, and/or scheduled alarms (e.g., using an integrated clock device).

For example, the computer devices 108 themselves, as well as individual components installed in the computer devices 108, may have designated operating lifetimes. The designated operating lifetimes refer to a predicted period of time that the components will be consistently operational before the components should be replaced. The designated operating lifetimes may be determined by manufacturers of the hardware components. The system controller 102 may set alarms to detect when the designated operating lifetimes reach the respective ends. The system controller 102 may also set alarms for tracking the expiration of warranty periods.

The system controller 102 may detect an issue when current software and/or firmware in a computer device 108 is determined to be outdated and/or a software update and/or firmware update is available for installation. For example, the system controller 102 may receive a message that indicates that an update is available. The system controller 102 may also detect an issue in response to determining that a component is defective (e.g., malfunctioning) and therefore should be replaced. For example, the system controller 102 may receive and monitor sensor signals indicating the conditions of various components of the monitored computer devices 108. The system controller 102 may detect that a first component is defective when the temperature of the first component is outside of an expected temperature range for that first component during normal operating conditions. In another example, the system controller 102 may detect that a second component is defective in response to an output power or signal generated by the second component being outside of an expected power range or an expected signal range. The signal range may be frequency, amplitude, or the like.

In response to detecting an issue, the system controller 102 determines a remedial action to address the issue. The remedial action may be determined based on the type or category of the issue. For example, if the issue is that a first component is defective, then the system controller 102 may determine, as the remedial action, that the first component should be replaced with new hardware. In another example, if the issue is that the warranty of the computer device 108 is expiring, the system controller 102 may determine, as the remedial action, to renew the warranty. If the issue is that software of a computer device 108 is outdated, the remedial action determined by the system controller 102 may be to update the software. The same is true for outdated firmware. In another example, if the issue is that a hardware component is approaching the end of its designated operating lifetime, the system controller 102 may determine to replace, or at least schedule replacement of, the hardware component prior to the hardware component experiencing a fault. The remedial actions are determined by the system controller 102 as actions that can be performed to reduce the risk that the group 106 of monitored computer devices 108 experience an interruption in service. The system controller 102 determines the remedial actions to avoid or limit downtime in which the computer devices 108 are not operating.

In the examples above, the individual issues and associated remedial actions to address and resolve the issues constitute respective task items. For example, a first task item may be to perform a first remedial action to resolve a first issue regarding a first computer device 108 in the group 106 of monitored computer devices 108. Similar task items may be grouped together and addressed as one task set. For example, the task windows 206, 208 shown in FIGS. 2-4 may be task sets that each address multiple individual task items. The system controller 102 may compile task items to provide the technical benefit of reducing the computational workload and energy expenditure of the computer management system 100, relative to treating all task items separately. For example, the system controller 102 may be able to avoid some redundant operations by collectively handling multiple related task items. The system controller 102 may generate the notification messages to display and describe task sets, rather than each individual task item. The GUI 202 depicting the task windows 206, 208 may be more organized and intuitive than GUIs depicting a plurality of individual task items. As a result, it may be easier for the user viewing the display device 116 to visualize and comprehend the information that is presented.

The system controller 102 assigns the task item (or a task set of multiple task items) to one specific user of multiple different users for that assigned user to manage the task set as the primary user. The system controller 102 may assign users to different roles with respect to the management of different task items. For example, the system controller 102 may assign a second user to the role of secondary user. The system controller 102 may differentiate the graphical content that is displayed on the GUI 202 to a primary user from the graphical content that is displayed to a secondary user via a second user device 104. The system controller 102 may differentiate the content to provide concise, relevant, role-specific information. As a result, some user devices 104 may display at least some different information and options on the GUI 202 than other user devices 104.

In an example, the system controller 102 may assign role(s) for managing a given task item based on an analysis of multiple user factors. The user factors are selected as a means to quantitatively compare multiple users' fitness or appropriateness for managing the given task item. Some example user factors may include (i) proficiency or competency of the user in performing the remedial action, (ii) accessibility of the user to the computer device associated with the task item, (iii) physical proximity of the user to the computer device associated with the task item, (iv) availability of the user to perform the remedial action within a designated time period, and/or the like.

The proficiency of the user refers to the skill and experience level of the user with respect to the type of remedial action suggested. For example, a user with a high competency has performed a number of similar remedial actions in the past and/or has completed sufficient training to perform similar remedial actions. The user with high competency has developed skills due to the experience and/or training obtained, so the user predictably will be able to successfully perform the remedial action.

The accessibility of the user to the computer device associated with the task item may refer to the ability of the user to gain access (e.g., physical or virtual) to the relevant computer device 108. For example, the remedial action may require the user to have satisfactory credentials for making changes to the computer device 108. For example, a first remedial action may require the decision-making user to establish an upper-level authority position before permitting the user to approve the remedial action. The first remedial action may involve renewing the warranty on a computer device 108. If the assigned user has an upper-level authority position, then the assigned user would have access to the computer device 108 associated with the task item. The user may establish the identity and authority level of the user by inputting unique user credentials into the corresponding user device 104. For example, the user may input the credentials into the management application (e.g., program) 124 using the input device 122. A user that meets the requirements for gaining access to the computer device 108 associated with the task item may score well in the accessibility factor. A user that does not meet the requirements for gaining access to the relevant computer device 108 may score poorly in the accessibility factor.

The physical proximity of the user to the computer device 108 associated with the task item refers to the distance between the physical location of the user and the physical location of the computer device 108 associated with the task item. For example, a first user that is within or near a data center that contains the relevant computer device 108 would be more proximate than a second user in another city. The first user may be able to address the issue by performing the remedial action before the second user would be able to do so. The early intervention may reduce the risk of, or at least the negative effect of, an operating interruption of the computer devices 108. The first user that is closer to the affected computer device 108 may score higher in the physical proximity factor than the second user.

The availability of the user to perform the remedial action within a designated time period accounts for the schedules and conditions of the prospective users. For example, a first user may be out of town, and therefore unavailable, to perform a remedial action of replacing a defective hardware component in a relevant computer device 108. That first user would score lower in the availability factor than a second user that has earlier availability to replace the defective hardware component. The availability may also account for scheduling conflicts, illness that could render the user unavailable, and/or the like. For example, a third user may have a booked schedule for over a week. That third user may score lower in the availability factor than a fourth user that has an earlier time window for addressing the task set.

In an example, the system controller 102 may compare a pool of multiple different prospective users to one another with respect to multiple user factors to assign one or more roles among the users. The prospective users could be employees of an IT company, or the like. The one or more roles that are assigned may be the primary (or assigned) user, a secondary user, a tertiary user, and/or the like. The secondary user is a backup to the primary user. The tertiary user is a backup to the primary user and the secondary user. The system controller 102 may compare the users among at least two user factors, such as at least two of the four factors described above. In an example, the system controller 102 may compare the users among three or all four of the factors described above.

The system controller 102 may determine a weighted score for at least some of the prospective users based on weight values assigned to the different users with respect to the multiple user factors. The weighted score reflects the appropriateness of the respective user for managing a given task item. The system controller 102 may then assign the task item to one or more of the users based on a comparison of the weighted scores of the prospective users. For example, the system controller 102 may compare the weighted score of a first user, with respect to a first task item, to the weighted scores of other users. The system controller 102 may assign the first user as the primary user for handling the task item in response to determining that the weighted score of the first user is greater than the weighted scores of the other users. The system controller 102 may independently perform a similar analysis and comparison for each task item. For example, the weighted scores are specific to both the user and the task item (e.g., the remedial action). A given user may have two different weighted scores with respect to two different task items because the user may be more qualified or appropriate to handle one of the task items over the other task item.

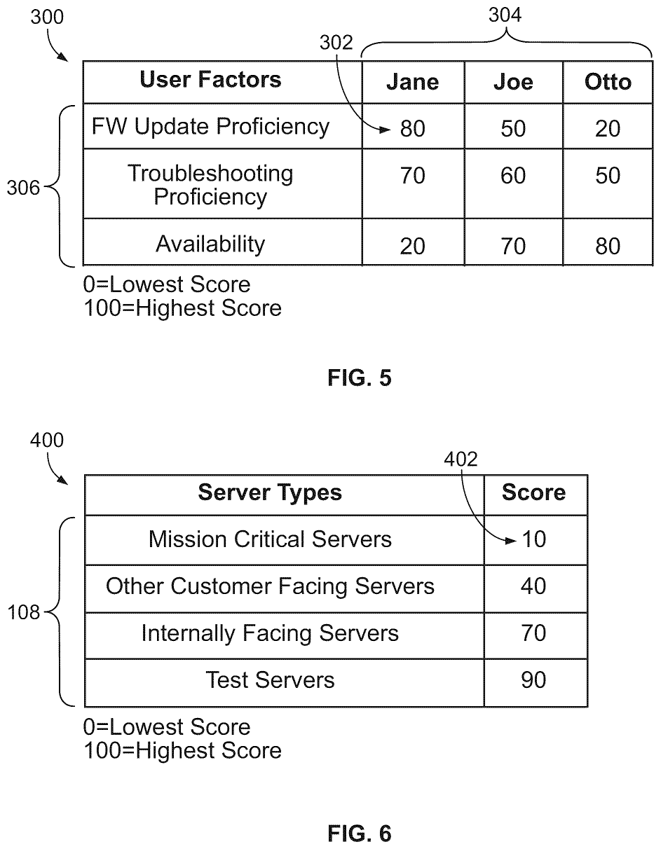

FIG. 5 is a chart 300 that lists weight values 302 assigned to three different users 304 for different factors 306 according to an embodiment. The chart 300 is referred to herein as a scoring rubric 300. The scoring rubric 300 may be stored in the memory 114 of the system controller 102. The system controller 102 (e.g., the processor(s) 112 thereof) may access and refer to the scoring rubric 300 to determine a weight score of each of the users with respect to a given task item. The information in the illustrated scoring rubric 300 is merely provided for example. The system controller 102 may refer to a scoring rubric that has different information (e.g., different user factors) in other examples. In FIG. 3, the three users 304 are identified as “Jane,” “Joe,” and “Otto.” The factors 306 listed are firmware update proficiency, troubleshooting proficiency, and availability. These factors are not specific to any one task item. The system controller 102 may refer to this scoring rubric 300 to determine a weighted score for each user specific to a given task item. The firmware update proficiency and troubleshooting proficiency factors fall within the competency category described above. The availability factor falls within the availability category described above.

Each user 304 is assigned a weight value 302 for each of the factors 306 listed in the scoring rubric 300. The weight values 302 in the illustrated example are numerical integers in the range from 0 to 100. The end value 0 represents that the user cannot do the task (e.g., cannot perform the remedial action). The end value 100 represents that the user is excellent at performing the task. The median value 50 represents that the user is average at performing the task. In an example, the weight values 302 indicate that Otto is more available than Jane and Joe, and Joe is more available than Jane. The user factors 306 shown in FIG. 5 are merely examples. The scoring rubric 300 optionally may have more than three user factors.

The system controller 102 may determine a subset of relevant user factors that are determined to be useful for selecting a user to perform and/or manage a given task item. For a task set relating to replacing a hardware component, the system controller 102 may determine that relevant user factors include the availability of the users, data center access, proximity to the data center, and hardware proficiency. The affected computer devices 108 that require the replacement part(s) may be located in the data center, so access and proximity to the data center may be relevant. The system controller 102 may determine weighted scores for the prospective users based on weight values (e.g., weight values 302) assigned to each user in the relevant user factors. For example, the system controller 102 may aggregate the weight values of the relevant factors for each individual user 304 to generate the weighted score for that user with respect to the task at issue. The system controller 102 may assign the users to roles for a task item based on a comparison of the weighted scores. In an example, the system controller 102 may assign Joe to the primary user role because Joe's weighted score for the task item is greater than the weighted scores of Jane and Otto. This weighted score comparison indicates that Joe is determined to be the most appropriate user for managing the task item (out of the three analyzed users). For example, the system controller 102 may predict that Joe has the greatest likelihood of accurately and effectively resolving the task item. The system controller 102 may assign Otto as a secondary user and Jane as a tertiary user for managing the specific task item. In another example, the weight values may be scored differently to produce weighted scores, but the system controller 102 still compares the weighted scores to select the primary user and optionally at least one backup role.

The system controller 102 may determine the automation level for the task item based on one or more automation factors. The system controller 102 uses the automation factors to determine which automation level is more appropriate, than at least one other automation level, for addressing the specific task item and for interacting with the primary user. For example, the automation levels may be high, low, and intermediate, as described above.

A first factor of the one or more automation factors may be a proficiency of the primary user at managing the task item at issue. The proficiency factor refers to how competent (e.g., skilled and experienced) the primary user is at handling the issue of the task item. An aspect of the proficiency factor may be the experience level of the user with managing previous task items that have respective issues that are the same or similar to the issue of the task item. The system controller 102 may analyze a relationship between the primary user and the previous, related task items. The relationship analysis may include analyzing historical data associated with the user managing the previous, related task items. The historical data may include a number of similar task items previously managed by the user, a success rate of the user at managing the previous, related task items, or a training level of the user at managing the task item and related task items. The training level may refer to classes, certifications, degrees, and/or the like.

The system controller 102 may select the automation level that is proportional to the proficiency level of the primary user at managing the task item. For example, the system controller 102 may select the high automation level in response to determining that the primary user has a high proficiency level at managing the type of task at issue. The system controller 102 may select the low automation level in response to determining that the primary user has a low proficiency level at managing the type of task at issue, and may select the intermediate automation level if the primary user is determined to have an intermediate or mid-level proficiency at managing the type of task. For example, if the user is an experienced veteran that has completed similar tasks dozens or even hundreds of times in the past, then the system 100 may select the high automation level for managing the task item. If the remedial action is determined to order a replacement part, the system controller 102 operating with the high automation level may automatically order the part, and may provide the primary user the opportunity to track the shipment, as shown in FIG. 4. On the other hand, if the primary user is a novice at managing the type of task item, the system controller 102 may select the low automation level. The system controller 102 may generate a notification message to target the novice user by providing instructions for ordering and/or installing the replacement part. The low automation level ensures that the user takes an active role in the task administration to help the user gain experience and confidence at performing the remedial action.

The automation factors may include a risk tolerance of the task item. The risk tolerance refers to direct and collateral damage that would occur if the task item is not effectively and/or correctly resolved by the primary user. For example, an update to a mission critical server may have a lower risk tolerance than an update to a test server because the detrimental effect of the mission critical server failing is significantly greater than if a test server goes down. A fault in the mission critical server would interrupt a greater number of computer devices and people than a fault in the test server. Tasks that have a lower risk tolerance have a greater level of risk or harm than tasks with a greater risk tolerance. Another example of a low risk tolerance task item may be updating production servers. A production server may be the primary environment used to host and serve live applications or websites to end users. Unlike developmental or staging servers, which are designed for testing or refining applications, a production server runs the finalized, public-facing version of an application. Updating the production server may be categorized as a high risk action because the consequences of an unsuccessful update may be significant.

The system controller 102 may select an automation level that is proportional to the risk tolerance. For example, task items with low risk tolerances may be less automated. The low automation level for these low tolerance tasks forces the primary user to be involved. The attention provided by the primary user may reduce the risk of the task item being incorrectly handled by the system controller 102. Lower risk tasks may have higher risk tolerances, and therefore may be more automated (e.g., need less manual intervention). If a given task item is identified as having a high risk tolerance, then the system controller 102 may select the high automation level for managing that task item. Automating the handling of that task item may improve efficiency and reduce strain on the primary user. For example, the primary user is allowed to devote more attention to higher risk tasks (with lower risk tolerances).

In an example, the system controller 102 may consider multiple automation factors to determine which automation level to use for managing a given task item. For example, the system controller 102 may consider both the proficiency level of the primary user at managing the task item and the risk tolerance of the task item. The system controller 102 may consider values assigned to different users and to different types of tasks to determine which automation level to use.

FIG. 6 is a chart 400 that includes score values 402 representing the risk tolerance of different computer devices 108 in the group 106 of monitored computer devices 108. The score values 402 are integers in the range from 0 to 100. The end value 0 represents the lowest risk tolerance, and the other end value 100 represents the highest risk tolerance. The listed computer devices 108 include mission critical servers, other customer facing servers, internally facing servers, and test servers. The assigned score values 402 indicate that the mission critical servers have the lowest risk tolerance, followed by the other customer facing servers, the internally facing servers, and lastly the test servers.

In an example, the system controller 102 may factor both the relevant weight value(s) 302 that indicate the proficiency of the assigned primary user and the score value 402 representing the risk tolerance of the affected computer device 108 associated with the task item. For example, if the task item involves a firmware update on a mission critical server and the primary user is Joe, the system controller 102 may obtain the weight value “50” from the scoring rubric 300 in FIG. 5 (which represents Joe's firmware update proficiency) and the score value “10” from the chart 400 in FIG. 6 (which represents the risk tolerance). If referring only to Joe's proficiency, the system controller 102 may select the intermediate automation level for the task item. In an example in which the system controller 102 considers both factors, the low risk tolerance may cause the system controller 102 to select the low automation level. For example, the system controller 102 may determine an average of the two values “10” and “50” to be “30”. That aggregated value of “30” may be within a designated range associated with the low automation level (e.g., more manual). In another example, if the task item involves a firmware update on a test server and the primary user is Joe, the high score value 402 of “90” referring to the risk tolerance of the test server may cause the system controller 102 to select the high automation level for managing that task item.

The system controller 102 optionally may consider one or more other automation factors when selecting the automation level. For example, one automation factor may be a success rate, or outcome, of previous tasks that are related to the current task at issue. If previous related tasks were successfully completed, then the system controller 102 may select a higher automation level. If previous related tasks were difficult and/or unsuccessful, then the system controller 102 may select a lower automation level. Different type of tasks, such as the type of issue and/or type of remedial action to address the issue, may be assigned values based on the success rate of previous related tasks. The assigned values may be similar to the values 302, 402 shown in FIGS. 5 and 6. The system controller 102 may use the assigned values based on the success rate to select the automation level.

In an example scenario, the system controller 102 determines that a firmware update is needed for a mission critical server. As indicated in FIG. 6, the mission critical server has a very low risk tolerance. In an example, the system controller 102 may use the risk tolerance factor for selecting which user is assigned the primary user role. In this scenario, the system controller 102 may assign the task item to Jane because, as shown in FIG. 5, Jane has the highest firmware update proficiency of the three prospective users. Jane's weight value for update proficiency is “80.” The scoring rubric 300 in FIG. 6 also indicates that Jane has a low availability. For example, Jane may be currently out of town. In response to the low availability, the system controller 102 may target the firmware update on the mission critical server to take place when Jane is available. For example, the system controller 102 may select the low automation level for the task item and may schedule the remedial action of updating the firmware to occur within 20 days.

If a less-critical internal server (e.g., intranet) needs new firmware, then it would weigh higher for automation. The system controller 102 may select the high automation level. Because the update will be highly automated, the assigned primary user only needs to monitor the update. The system controller 102 may assign that task item to a less proficient user that is available, such as Otto. Otto is the least proficient user at firmware updates, as indicated by the weight value of “20” in FIG. 5, but Otto is determined fit to monitor the automated task administration.

After determining the automation level, the system controller 102 generates a notification message with graphical content that is based on the automation level. The notification message is generated for presentation on a display device 116. The graphical content in the notification message identifies the issue of the task item and the remedial action to resolve the issue. The graphical content in the notification message is based on the determined automation level so that different content is displayed to the primary user depending on the automation level. For example, the graphical content may include a virtual button that is displayed in a GUI. The text or other graphical markings on the virtual button may be associated with the remedial action of the task item. The text or graphical markings may differ depending on the automation level, even if the remedial action is unchanged.

In a low automation level, the graphical content of the notification message may display instructions for user-assisted performance of the remedial action and/or prompt the primary user to schedule an automated performance of the remedial action. An example notification message in the low automation level is shown in FIG. 2. In an intermediate automation level, the graphical content of the notification message may automatically perform the remedial action dependent on receiving consent (e.g., affirmance) from the primary user. Alternatively, the notification message may schedule for the automated performance of the remedial action at a future time, still dependent on receiving consent from the primary user. An example intermediate automation level notification message is shown in FIG. 3. In a high automation level, the graphical content of the notification message may automatically perform the remedial action independent of receiving consent from the primary user. Alternatively, the notification message may schedule for automated performance of the remedial action at a future time, still independent of receiving consent from the primary user. An example high automation level notification message is shown in FIG. 4.

The system controller 102 may also vary the graphical content of the notification message based on the role of the user that receives the notification device. For example, the notification message that is sent to the primary user may have at least slightly different text and/or other graphical content than a notification message that is sent to the secondary user about the same task item.

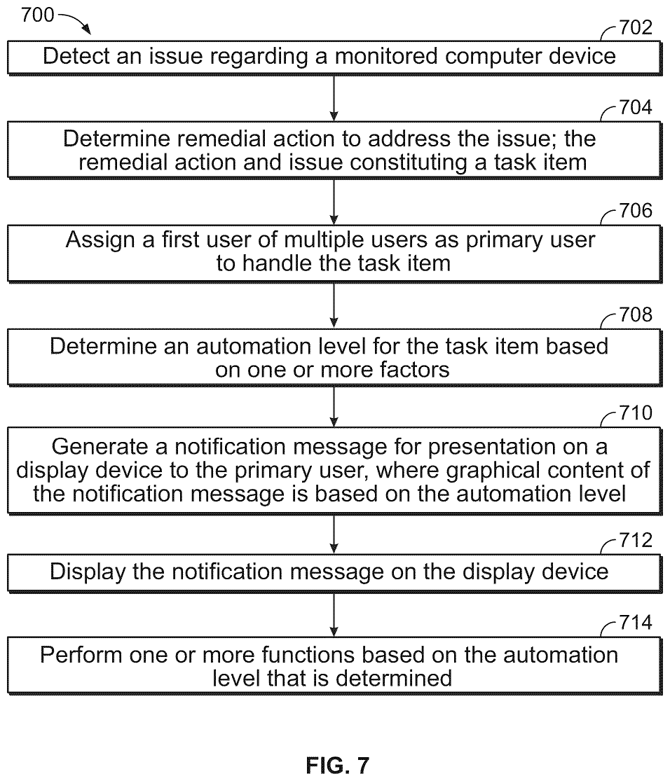

FIG. 7 is a flow chart of a method of managing and monitoring computer devices according to an embodiment. The method may be performed entirely or in part by the system controller 102 (e.g., the one or more processors 112) of the computer management system 100. The method optionally may include at least one additional step than shown in FIG. 7, at least one fewer step than shown in FIG. 7, and/or at least one different step than shown in FIG. 7.

At step 702, an issue is detected regarding a first computer device 108 in a group 106 of monitored computer devices 108. The issue may be an expiring warranty, outdated software, outdated firmware, a defective hardware component, a hardware component approaching an end of a designated operating lifetime of the hardware component, and/or the like.

At step 704, a remedial action is determined to address the issue. The issue and the remedial action constitute a task item. The remedial action to address the issue may include renewing the warranty of the first computer device that is expiring, updating the software that is outdated, updating the firmware that is outdated, ordering at least one hardware component for the first computer device 108 to replace the defective hardware component or the hardware component that is approaching the end of the designated operating lifetime, and/or the like.

At step 706, the task item is assigned to a first user of multiple different users for the first user to manage (e.g., resolve) the task item. The task item may be assigned to the first user by comparing the multiple different users with respect to multiple user factors. The factors may be used to determine how appropriate each user would be for handling the task item. The user factors may include (i) competency in performing the collective remedial action, (ii) accessibility to the computer devices 108 associated with the task item, (iii) proximity to the computer devices 108 associated with the task item, and/or (iv) availability to perform the collective remedial action within a designated time period. The system controller 102 may evaluate the users on multiple user factors, such as two, three, or all four of the factors listed. The system controller 102 may determine a weighted score for at least some of the multiple different users based on weight values assigned to the different users with respect to the multiple user factors. The system controller 102 may assign the task item to the first user by comparing the weighted score of the first user to the weighted scores of other users in the multiple different users. For example, the system controller 102 may select the first user for having a primary role in response to the weighted score of the first user being greater than the weighted scores of the other users. The greater weighted score may indicate that the first user is more appropriate for managing the task item than the other users.

At step 708, an automation level for the task item is determined based on one or more automation factors. The automation level represents an extent of user involvement that is required to achieve the remedial action. Different automation levels require different extents of involvement by the primary user. A first factor of the automation factor(s) is a proficiency of the primary user at managing the task item. The automation level may be selected to be proportional to a level of the proficiency of the primary user. The one or more automation factors may also include at least one of a risk tolerance associated with the task item (or the affected computer device 108) or a success rate of prior task items that have respective issues that are the same or similar to the issue of the task item.

At step 710, a notification message is generated for presentation on a display device 116. The display device 116 may be associated with a specific user, such as the primary user. The notification message includes graphical content that identifies the issue and the remedial action to address the issue. The notification message is generated so that the graphical content that is displayed is based on the automation level that is determined. The notification message may be generated to present at least a first virtual button 214 on a GUI 202. The virtual button 214 may be presented to affirm and/or initiate the remedial action. The graphical content on the virtual button 214, and the effect or output of selecting the virtual button 214, may vary depending on the automation level.

At step 712, the notification message is displayed on a screen 204 of the display device 116 for viewing by the primary user. Generating the notification message may include providing a virtual button on a graphical user interface (GUI) 202. The virtual button may be an affirmance button 214 associated with the remedial action of the task item.

At step 714, the system controller 102 performs one or more functions based on the automation level that is determined. For example, when the automation level is a high automation level, the method includes one of (i) automatically performing the remedial action or (ii) scheduling for automated performance of the remedial action at a future time, independent of receiving consent from the primary user. When an intermediate automation level is determined, the method includes one of (iii) automatically performing the remedial action or (iv) scheduling for the automated performance of the remedial action at the future time, with both options being dependent on receiving consent from the primary user. When a low automation level (e.g., more manual) is determined, the method includes one of (v) displaying instructions on the display device for user-assisted performance of the remedial action or (vi) prompting the primary user to schedule automated performance of the remedial action.

In an example, the system controller 102 of the computer management system 100 may include a machine learning algorithm. The machine learning algorithm may be used to determine the remedial action to resolve an issue, to assign a role to at least one user for managing the task item, and/or to determine the automation level for the task item. For example, the machine learning algorithm may allow the computer management system 100 to intelligently determine the automation level based on the one or more automation factors. In an example, the machine learning algorithm may be stored in the memory 114 of the system controller 102. In another example, the machine learning algorithm may be integrated into the one or more processors 112.

The machine learning algorithm may include multiple layers of artificial neurons (or nodes) connected with each other by functional relationships or edges (e.g., circuits), which model the synapses in a brain. The layers may include an input layer, an output layer, and one or more intermediate layers referred to as hidden layers. The neurons may be processors and/or functions performed by processors. The functional relationships may be rules (e.g., logic rules), mathematical equations, and/or the like. Each neuron receives signals from connected neurons as inputs. The neuron generates an output that is a non-linear function of the sum of its inputs. The strength of the signal at each connection is determined by a weight, which is adjusted during a learning process. The output of each neuron may be transmitted to other neurons in another layer. The final output of the machine learning algorithm may be used to adjust the weights of the neurons. For example, if the final output is determined to be wrong or inaccurate, then the weights are adjusted to change the relationships between the nodes and reduce the likelihood of yielding the same incorrect output in the future. By this feedback mechanism, the machine learning algorithm may continue to improve over time.

In the computer management system 100, the machine learning algorithm may receive, as inputs, an identification of the detected issue and an identity of the user that is selected for the primary user role. Optionally, the determined remedial action for addressing the issue may be another input to the machine learning algorithm. Optionally, the machine learning algorithm may have access to various information about the users, the computer devices that are monitored, and the task items. The information can include values assigned to different users for proficiency at different tasks, risk tolerance values assigned to different computer devices and/or tasks, and/or the like. The machine learning algorithm may analyze the input information through the layers of neurons in a forward propagation direction. The machine learning algorithm may apply rules and/or criteria to the information and reach a conclusion in the form of an output. The output of the machine learning algorithm may identify an automation level that is appropriate for handling a given task item and for notifying the primary user about the task item.

The system controller 102 (optionally with assistance by a user) may determine that the output is incorrect and/or inaccurate because there is too much error. The system controller 102 may change the rules, weights, and/or criteria in the neurons and synaptic circuits. For example, the system controller 102 may alter the functions performed by some neurons, the synaptic circuit connections between the neurons (e.g., which neurons communicate with which neurons in the neural network), the weights of the signals, and/or the like. Then, the system controller 102 may perform the operation again using the adjusted machine learning algorithm to reach an updated output. The updated output may have less error, and therefore be more correct, than the initial output. The system controller 102 may change the synaptic circuits (e.g., the relationships between the neurons) based on feedback (e.g., error, back propagation, etc.) received from earlier machine learning analysis to reach a more accurate result.

### CLOSING STATEMENTS

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), complex instruction set computer (CISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

In one embodiment, the computer management system may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, SVMs, Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B” represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method comprising:
detecting an issue regarding a first computer device in a group of monitored computer devices;
determining, via one or more processors, a remedial action to address the issue, the issue and the remedial action constituting a task item;
assigning the task item to a first user of multiple different users for managing the task item;
determining, via the one or more processors, an automation level for the task item based on one or more factors, wherein a first factor of the one or more factors is a proficiency of the first user at managing the task item, and the automation level represents an extent of user involvement that is required to achieve the remedial action; and
generating, via the one or more processors, a notification message for presentation on a display device, the notification message including graphical content that identifies the issue and the remedial action to address the issue, wherein the notification message is generated so that the graphical content that is displayed is based on the automation level.

2. The method of claim 1, wherein determining the automation level for the task item comprises selecting the automation level to be proportional to a level of the proficiency of the first user at managing the task item.

3. The method of claim 1, further comprising one of (i) automatically performing the remedial action or (ii) scheduling for automated performance of the remedial action at a future time, independent of receiving consent from the first user, when the automation level is a high automation level.

4. The method of claim 3, further comprising one of (iii) automatically performing the remedial action or (iv) scheduling for the automated performance of the remedial action at the future time, dependent on receiving consent from the first user, when the automation level is a second automation level that is less automated than the high automation level.

5. The method of claim 4, further comprising one of (v) displaying instructions on the display device for user-assisted performance of the remedial action or (vi) prompting the first user to schedule automated performance of the remedial action, when the automation level is a third automation level that is less automated than the second automation level.

6. The method of claim 1, wherein another factor of the one or more factors is a risk tolerance associated with the task item.

7. The method of claim 6, wherein determining the automation level for the task item comprises selecting the automation level to be less automated when the task item has a low risk tolerance and selecting the automation level to be more automated when the task item has a high risk tolerance.

8. The method of claim 1, wherein another factor of the one or more factors is a success rate of prior task items that have respective issues that are the same or similar to the issue of the task item.

9. The method of claim 1, wherein determining the automation level for the task item comprises inputting an identification of the issue and an identity of the first user to a machine learning algorithm.

10. The method of claim 1, wherein the issue regarding the first computer device comprises one or more of an expiring warranty, outdated software, outdated firmware, a defective hardware component, or a hardware component approaching an end of a designated operating lifetime of the hardware component, and
the remedial action to address the issue comprises one or more of renewing the warranty of the first computer device that is expiring, updating the software that is outdated, updating the firmware that is outdated, or ordering at least one hardware component for the first computer device to replace at least one of the defective hardware component or the hardware component that is approaching the end of the designated operating lifetime.

11. The method of claim 1, wherein generating the notification message comprises presenting a virtual button on a graphical user interface, the virtual button presented to prompt the first user to one of affirm or initiate the remedial action, based on the automation level that is determined.

12. The method of claim 1, further comprising:
determining a weighted score for at least some of the multiple different users based on weight values assigned to the different users with respect to multiple user factors; and
wherein assigning the task item to the first user comprises comparing the weighted score of the first user to the weighted scores of other users in the multiple different users.

13. The method of claim 1, further comprising displaying the notification message on a screen of the display device for viewing by the first user.

14. The method of claim 1, wherein generating the notification message comprises presenting a virtual button on a graphical user interface, wherein the notification message is generated so that graphical content on the virtual button prompts the first user to track progress of the remedial action when the automation level is a high automation level and the graphical content on the virtual button prompts the first user to initiate the remedial action when the automation level is a low automation level.

15. A computer management system comprising:
a memory configured to store program instructions; and
one or more processors operably connected to the memory, wherein the program instructions are executable by the one or more processors to:
detect an issue regarding a first computer device in a group of monitored computer devices;
determine a remedial action to address the issue, the issue and the remedial action constituting a task item;
assign the task item to a first user of multiple different users for managing the task item;
determine an automation level for the task item based on one or more factors, wherein a first factor of the one or more factors is a proficiency of the first user at managing the task item, and the automation level represents an extent of user involvement that is required to achieve the remedial action; and
generate a notification message for presentation on a display device, the notification message including graphical content that identifies the issue and the remedial action to address the issue, wherein the notification message is generated so that the graphical content that is displayed is based on the automation level.

16. The computer management system of claim 15, wherein the program instructions are executable by the one or more processors to determine the automation level for the task item by selecting the automation level to be proportional to a proficiency level of the first user at managing the task item.

17. The computer management system of claim 15, wherein the program instructions are executable by the one or more processors to one of (i) automatically perform the remedial action or (ii) schedule for automated performance of the remedial action at a future time, independent of receiving consent from the first user, when the automation level is a high automation level.

18. The computer management system of claim 17, wherein the program instructions are executable by the one or more processors to one of (iii) automatically perform the remedial action or (iv) schedule for the automated performance of the remedial action at the future time, dependent on receiving consent from the first user, when the automation level is a second automation level that is less automated than the high automation level.

19. The computer management system of claim 18, wherein the program instructions are executable by the one or more processors to one of (v) display instructions on the display device for user-assisted performance of the remedial action or (vi) prompt the first user to schedule automated performance of the remedial action, when the automation level is a third automation level that is less automated than the second automation level.

20. A computer program product comprising a non-transitory computer readable storage medium, the non-transitory computer readable storage medium comprising computer executable code configured to be executed by one or more processors to:
detect an issue regarding a first computer device in a group of monitored computer devices;
determine a remedial action to address the issue, the issue and the remedial action constituting a task item;
assign the task item to a first user of multiple different users for managing the task item;
determine an automation level for the task item based on one or more factors, wherein a first factor of the one or more factors is a proficiency of the first user at managing the task item, and the automation level represents an extent of user involvement that is required to achieve the remedial action; and
generate a notification message for presentation on a display device, the notification message including graphical content that identifies the issue and the remedial action to address the issue, wherein the notification message is generated so that the graphical content that is displayed is based on the automation level.
